(19) United States
(12) Patent Application Publication
(10) Pub. No.: US 2008/0307838 A1
(43) Pub. Date: Dec. 18, 2008

(54) COMBINED KEY AND COMBINATION RESETTABLE LOCK

(75) Inventor: Wang Chia HUNG, Chung-Ho City (TW)

Correspondence Address: Muncy, Geissler, Olds & Lowe, PLLC, P.O. BOX 1364, FAIRFAX, VA, 22038-1364, US

(73) Assignee: SINOX CO., LTD.

(21) Appl. No.: 12/138,029

(22) Filed: Jun. 12, 2008

Related U.S. Application Data
(60) Provisional application No. 60/943,773, filed on Jun. 13, 2007.

(51) Int. Cl. E05B 37/00

(52) U.S. Cl. 70/284

(57) ABSTRACT

A combined key and combination resettable lock is disclosed. The combination lock has a set of shaft and a set of parallel number wheels, and the set of shaft is axially movable and enclosed by the parallel number wheels. The key lock has a lock body and an outer sleeve, and the outer sleeve is selectively rotatable in accordance with the lock body. The outer sleeve further includes a protrusion and comes into contact with one end of the set of shaft. The outer sleeve is rotatable to a reset position, and the protrusion is against and presses the end of the set of shaft when the outer sleeve rotates to the reset position.

### BACKGROUND OF THE INVENTION

1. Field of the Invention

The present invention relates generally to combined key and combination locks, and more particularly to a combined key and combination resettable lock.

2. Description of the Prior Art

Securing one's possessions has long been a concern of people throughout the world. Various locks are frequently used to restrict and prevent unauthorized access to valuables and safeguard them against theft, damage and sabotage. Although an individual with ill intent may open most locks with proper tools in a few hours or even in a few minutes, locks are still considered a practical device and used primarily to deter, discourage and delay unapproved access to personal property. Most people in modern society use keys on a daily basis, and a somewhat more sophisticated lock, namely combination lock, are employed constantly as well.

Traditional key locks effectively impede access to the restricted areas or articles, and this low-tech approach is not only simple but also inexpensive. Conventional combination locks provide a certain degree of security without the use of a key and the issues of key being lost or stolen. However, low-tech locks are often susceptible to direct mechanical attacks. Consequently, a more robust combination lock combined with a key lock has been created to couple unique advantages of both locks.

For most resettable combination locks combined with key locks, the sequence reset operation is usually performed while the key lock is in its unlocked position, and the user may change the combination unintentionally or unknowingly when the number wheels are turned accidentally either by the user or by touching with other objects. To avoid such nonplussed circumstances, what is desired is a resettable combination lock combined with a key lock that the combination is only resettable in a position rather than the unlocked position of the key lock. What is also needed is a resettable combination lock combined with a key lock that the lock mechanism can be open by unlocking the key lock only.

### SUMMARY OF THE INVENTION

One object of the present invention is to provide a resettable combination lock combined with a key lock that the lock mechanism can be open by unlocking the key lock only.

Another object of the present invention is to provide a resettable combination lock combined with a key lock that the combination can be reset in the reset position only, instead of the unlocked position of the key lock in the prior art, to prevent the combination from being changed unintentionally.

Still another object of the present invention is to provide a resettable combination lock combined with a key lock designed to work with two different keys, the change key and master key.

Yet another object of the present invention is to provide a resettable combination lock combined with a key lock applied to lockers for rent, such as those in schools, department stores, shopping centers and the like.

In accordance with the above and other objects of the present invention, a lock mechanism comprising a combination lock and a key lock is disclosed. The combination lock has a set of shaft and a set of parallel number wheels, wherein the set of shaft is axially movable and enclosed by the parallel number wheels. The key lock has a lock body and an outer sleeve, the outer sleeve is selectively rotatable in accordance with the lock body, wherein the outer sleeve further includes a protrusion and is contacted with one end of the set of shaft. The outer sleeve is rotatable to a reset position, and the protrusion is against and presses the end of the set of shaft when the outer sleeve rotates to the reset position.

The set of shaft further includes a shaft and an inner sleeve, the shaft has a plurality of knobs operatively engaged with the inner sleeve, and the inner sleeve is movably engaged with the number wheels. The set of shaft is movable between a first position and a second position, the set of shaft engages with the number wheels when the protrusion presses the set of shaft to the first position, and the set of shaft disengages from the number wheels when the protrusion presses the set of shaft to the second position.

The lock mechanism of the present invention further comprises a base, wherein the combination lock and the key lock are mounted respectively on the base. The lock mechanism further comprises a housing enclosing the combination lock and the key lock, wherein a plurality of openings corresponding to the number wheels are formed on the housing. The protrusion in on peripheral surface of the outer sleeve. The protrusion includes a cam which occupies one-quarter circumference of the outer sleeve. One end of the cam is connected to the outer sleeve and the other end of the cam protrudes out of the outer sleeve. In other embodiments, one end of the protrusion is connected to the outer sleeve and the other end of the protrusion protrudes out of the outer sleeve.

The end of the set of shaft further includes a ring. The lock mechanism of the present invention further comprises a concavity on the protrusion and a knob on the ring, wherein the concavity is disposed corresponding to the knob when the protrusion collides against the ring. The lock body has a pushing portion and the outer sleeve has a flange, the pushing portion moves the flange to the reset position when the protrusion collides against the ring. The lock mechanism of the present invention includes a cabinet lock.

A lock with a resettable combination is also disclosed. The lock with a resettable combination comprises a combination lock and a key lock. The combination lock has a set of shaft and a set of parallel number wheels, wherein the set of shaft is axially movable and enclosed by the parallel number wheels. The key lock has a lock body and an outer sleeve, the outer sleeve is selectively rotatable in accordance with the lock body, wherein the outer sleeve further includes a protrusion and is contacted with one end of the set of shaft. The outer sleeve is rotatable to a reset position, and the protrusion is against and presses the end of the set of shaft when the outer sleeve rotates to the reset position.

The set of shaft further includes a shaft and an inner sleeve, the shaft has a plurality of knobs operatively engaged with the inner sleeve, and the inner sleeve is movably engaged with the number wheels. The set of shaft is movable between a first position and a second position, the set of shaft engages with the number wheels when the protrusion presses the set of shaft to the first position, and the set of shaft disengages from the number wheels when the protrusion presses the shaft to the second position.

The lock with a resettable combination of the present invention further comprises a base, wherein the combination lock and the key lock are mounted respectively on the base. The lock with a resettable combination further comprises a housing enclosing the combination lock and the key lock, wherein a plurality of openings corresponding to the number wheels are formed on the housing. The protrusion in on peripheral surface of the outer sleeve. The protrusion includes a cam which occupies one-quarter circumference of the outer sleeve. One end of the cam is connected to the outer sleeve and the other end of the cam protrudes out of the outer sleeve. In other embodiments, one end of the protrusion is connected to the outer sleeve and the other end of the protrusion protrudes out of the outer sleeve.

The end of the set of shaft further includes a ring. The lock with a resettable combination of the present invention further comprises a concavity on the protrusion and a knob on the ring, wherein the concavity is disposed corresponding to the knob when the protrusion collides against the ring. The lock body has a pushing portion and the outer sleeve has a flange, the pushing portion moves the flange to the reset position when the protrusion collides against the ring. The lock with a resettable combination of the present invention includes a cabinet lock. The aforementioned objects, features and advantages will become apparent from the following detailed description of preferred embodiments taken together with the accompanying drawings.

### BRIEF DESCRIPTION OF THE DRAWINGS

FIG. 1 is a 3D view of a lock mechanism in accordance with one embodiment of the present invention.

FIG. 2 is a structural diagram of the combination lock of the lock mechanism in FIG. 1.

FIG. 3a is a structural diagram of the key lock of the lock mechanism in FIG. 1.

FIG. 3b to 3d are top views of the key lock in the locked status, in the unlocked status and in the reset status respectively in accordance with the present invention.

FIG. 3e is a bottom view of the key lock in the locked status.

FIG. 4a shows a schematic diagram of the bases of the lock mechanism in accordance with the present invention.

FIG. 4b is a bottom view of the bases and fixing sleeve when the key lock is in the locked status.

FIG. 4c is a bottom view of the bases and fixing sleeve when the key lock is in the unlocked status.

FIG. 5 shows a schematic diagram of the housing of the lock mechanism in accordance with the present invention.

FIG. 6 is an exploded view of the lock mechanism according to the present invention.

FIG. 7a to 7c show cross sectional views of the lock mechanism depicting the key lock is in the locked status, the unlocked status and the reset status respectively.

FIG. 8 is a cross sectional view of the lock mechanism showing the combination lock in the unlocked status.

### DETAILED DESCRIPTION OF THE PREFERRED EMBODIMENT

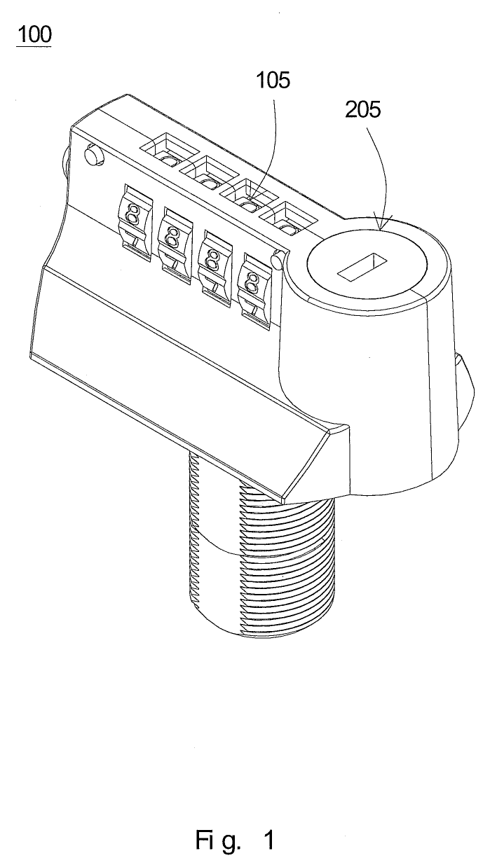

Various embodiments of the present invention described herein are for illustrative purposes only, not to limit the present invention. The present invention discloses a combined key and combination resettable lock, preferably used in lockers at school, shopping centers and the like. However, in other embodiments, the lock mechanism in accordance with the present invention may be employed in any places where a portable lock is needed. The lock mechanism in accordance with the present invention is preferably utilized as a cabinet lock; however, in other embodiments, the lock mechanism may be utilized as other types of locks. FIG. 1 shows a 3D view of such lock mechanism according to one embodiment of the present invention. The lock mechanism 100 in accordance with the present invention comprises a combination lock 105 and a key lock 205, as depicted in FIG. 1, the combination lock 105 possesses a roughly rectangular shape from the top view and the key lock 205 is substantially a cylinder, and the two locks are configured side by side.

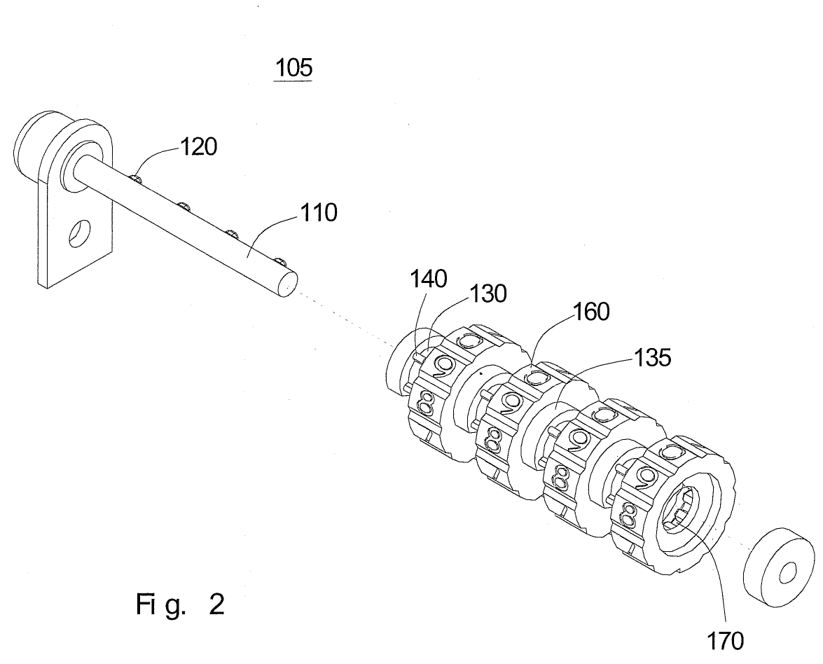

FIG. 2 is a structural diagram of the combination lock 105 of the lock mechanism 100 in FIG. 1. The combination lock 105 has a set of shaft and a set of parallel number wheels 160. The set of shaft further includes a shaft 110 and an inner sleeve 130. The surface of the shaft 110 has a plurality of knobs 120 operatively engaged with the inner sleeve 130, and the inner sleeve 130 is movably engaged with the number wheels 160. Every cavity 170 formed on the inside of the number wheels 160 are corresponding to each nodule 140 formed on the outer surface of the inner sleeve 130. In other words, the shaft 110 is encircled and enclosed by the inner sleeve 130, which is encircled and enclosed by the number wheels 160. Moreover, the set of shaft, namely the shaft 110 and the inner sleeve 130, is axially movable and enclosed by the parallel number wheels 160. In the preferred embodiment, the inner sleeve 130 is composed of four pieces of individual and small tubes 135, and each piece with one disk of the four number wheels 160 are assembled one by one, as shown in FIG. 2, and put around the shaft 110 to form the combination lock 105.

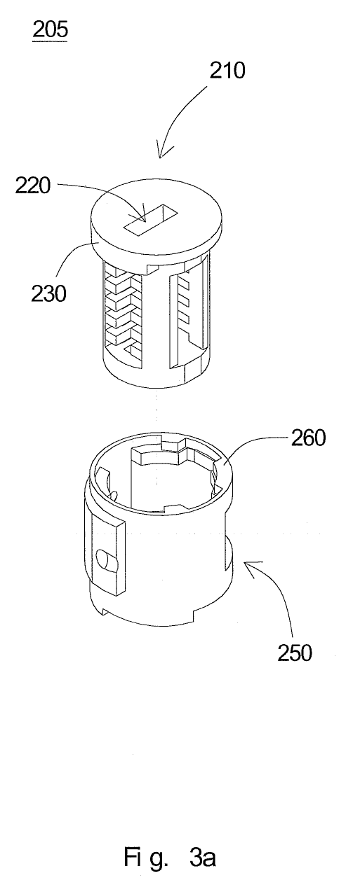

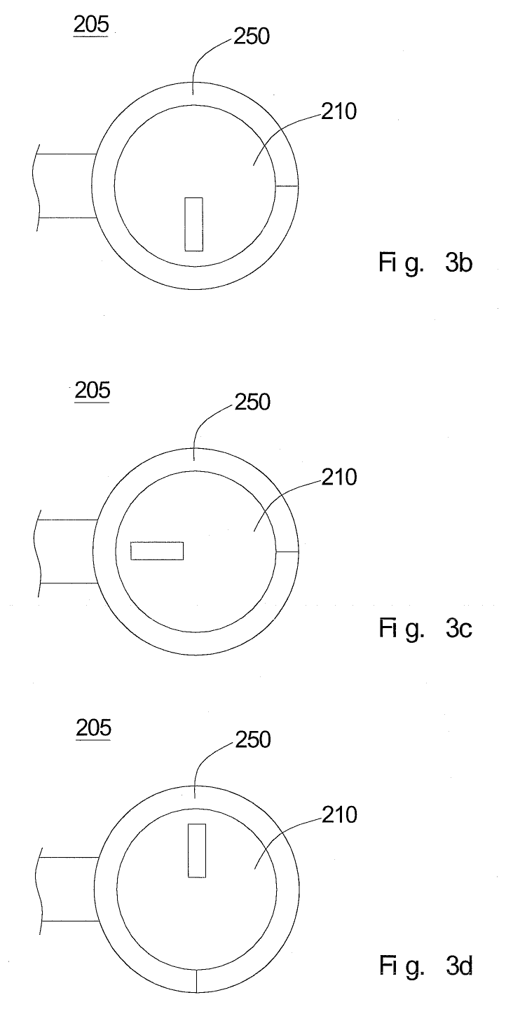

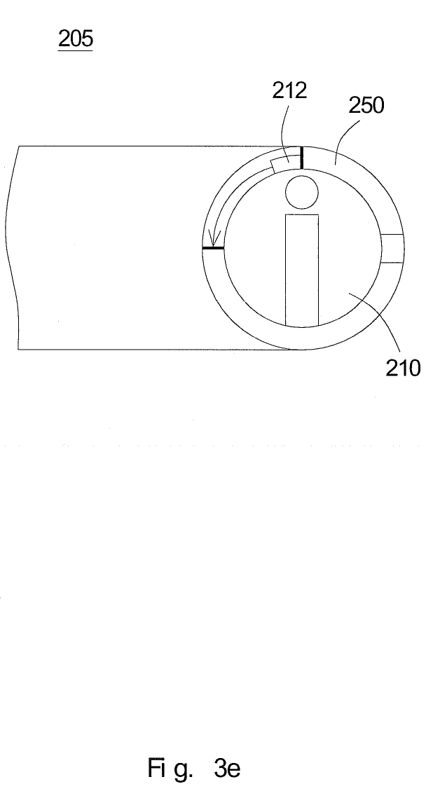

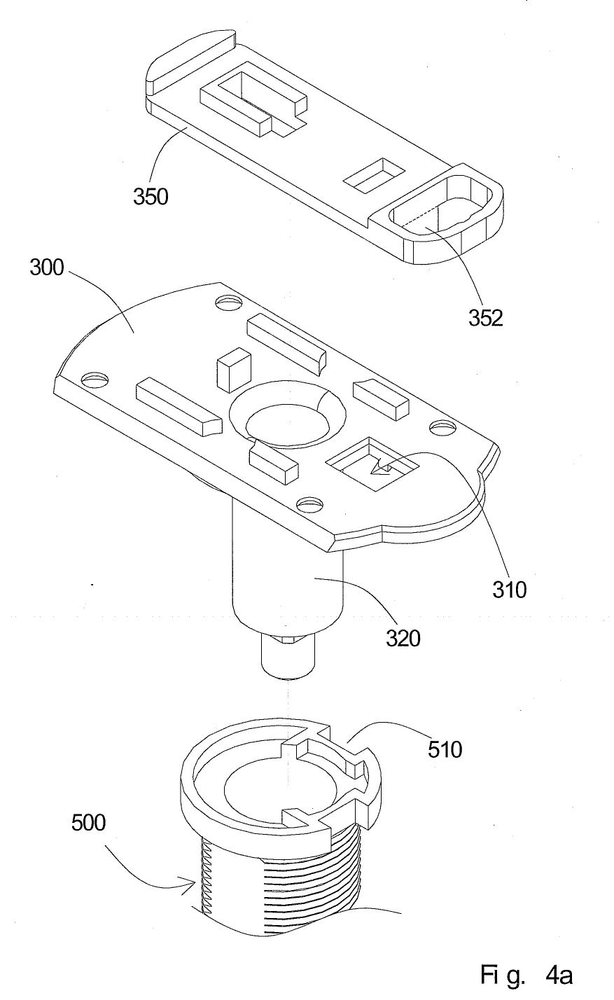

Please refer to FIG. 3a showing a structural diagram of the key lock 205 of the lock mechanism 100 in FIG. 1. The key lock 205 has a lock body 210 and an outer sleeve 250. A key hole 220 is formed on the top surface of the lock body 210, and the lock body 210 has three positions, i.e. a locked position, an unlocked position and a rest position. Corresponding to the three positions of the lock body 210, the key lock 205 has three statuses: a locked status, an unlocked status and a reset status, as illustrated in FIG. 3b, FIG. 3c and FIG. 3d respectively. In the preferred embodiment, the unlocked status is reached as the lock body 210 turns 90 degree from its locked position, and the reset status is reached as the lock body 210 turns another 90 degree from its unlocked position, thus the reset position of the lock body 210 is set 180 degree apart from the locked position. However, in other embodiments, other apparent and easily recognizable angles may be set, such as 180 degree between the locked position and unlocked position of the the lock body 210.

The outer sleeve 250 is selectively rotatable in accordance with the lock body 210. In this embodiment, the outer sleeve 250 is rotating together with the lock body 210 only while the lock body 210 is turning from the unlocked position to the reset position. FIG. 3e is a bottom view of the key lock 205 in the locked status. Since bottom rim of the outer sleeve 250 has a raised portion going substantially three quarters (270 degrees) of the way around the circle, as indicated by two bold lines in the outer sleeve 250, but is not limited thereto. The raised portion can be disposed at the top rim of the outer sleeve 250 and also can occupy other angles around the bottom rim of the outer sleeve 250. The lock body 210 has a metal plate 212 extending from near the bottom of the cylinder surface of the lock body 210 to interact with the raised portion of the outer sleeve 250, the lock body 210 is rotatable to only a quarter turn by itself, as the arrow in the figure shows, and will rotate together with the outer sleeve 250 from the unlocked position to the reset position.

Similar to conventional combination locks, or more precisely permutation locks, a proper sequence of numbers is required to open the combination lock 205 of the lock mechanism 100. However, it shall be noted that the lock mechanism 100 in accordance with the present invention can be opened by unlocking the key lock 205 only. In other words, if one has the right key to the key lock 205, that person can still open the entire lock mechanism 100 even though he/she does not know or forgot the right combination, but is not limited thereto. In other embodiments, one may have to know the right combination in order to reset the combination lock 105 even if the person has the key to unlock the key lock 205 and turns it to the reset position.

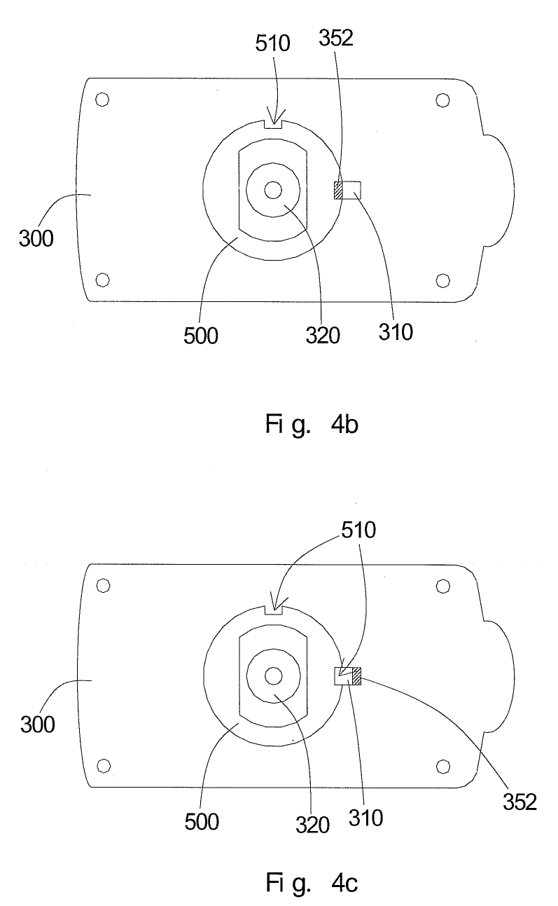

Please refer to FIG. 4a, the lock mechanism 100 in accordance with the present invention further comprises a base 300 with a central part 320 extending downward. A secondary base 350 is attached to the top of the base 300 and has a hitch 352 reaching out downward slightly in order to interact with the base 300. In this embodiment, the hitch 352 goes through a substantially square hole 310 formed on the base 300, and the secondary base 350 slides horizontally on the top of the base 300 between the range where the hitch 352 moves freely within the square hole 310.

Consequently, the combination lock 105 and the key lock 205 are mounted respectively on the secondary base 350 and the base 300. A fixing sleeve 500 may put around the extending-downward central part of the base 300 to facilitate lockup as the lock mechanism 100 in accordance with the present invention is applied as a cabinet lock. More than one notch 510 may form on the top rim of the fixing sleeve 500 for receiving the hitch 352 such that when the lock body 210 is in the locked position, the notch 510 clasp the hitch 352 and the fixing sleeve 500 cannot move, as shown in FIG. 4b depicting a bottom view of the two bases and fixing sleeve in accordance with the present invention. And when the lock body 210 turns to the unlocked position, the hitch 352 moves away from the notch 510 so the fixing sleeve 500 may move freely, as shown in FIG. 4c.

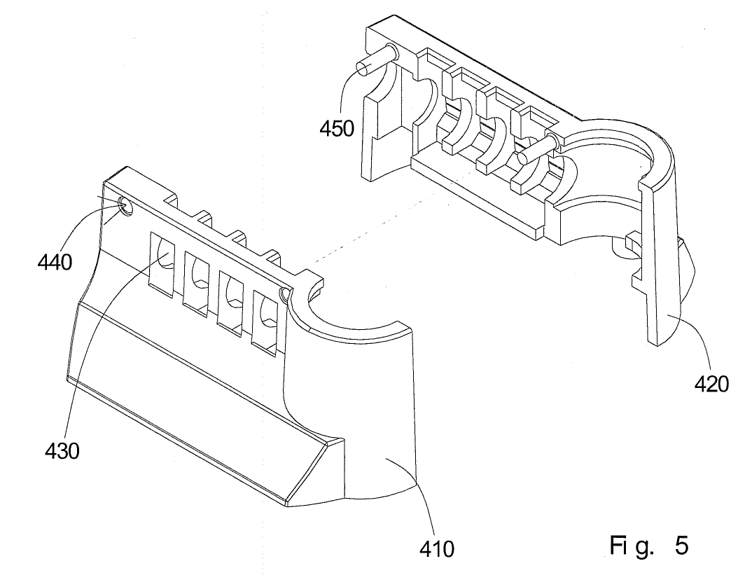

As shown in FIG. 5, the lock mechanism 100 in accordance with the present invention further comprises a housing enclosing the combination lock 105 and the key lock 205. In the preferred embodiment, the housing further includes a first housing 410 and a second housing 420, and a plurality of openings 430 corresponding to the number wheels 160 are formed on the housing 410 and 420 respectively to allow turning of the number wheels 160. One of the housings has a hole 440 formed thereon and the other housing has a post 450 disposed corresponding to the hole 440 to integrate two separate housings, the combination lock 105 and the key lock 205 into the final lock mechanism 100.

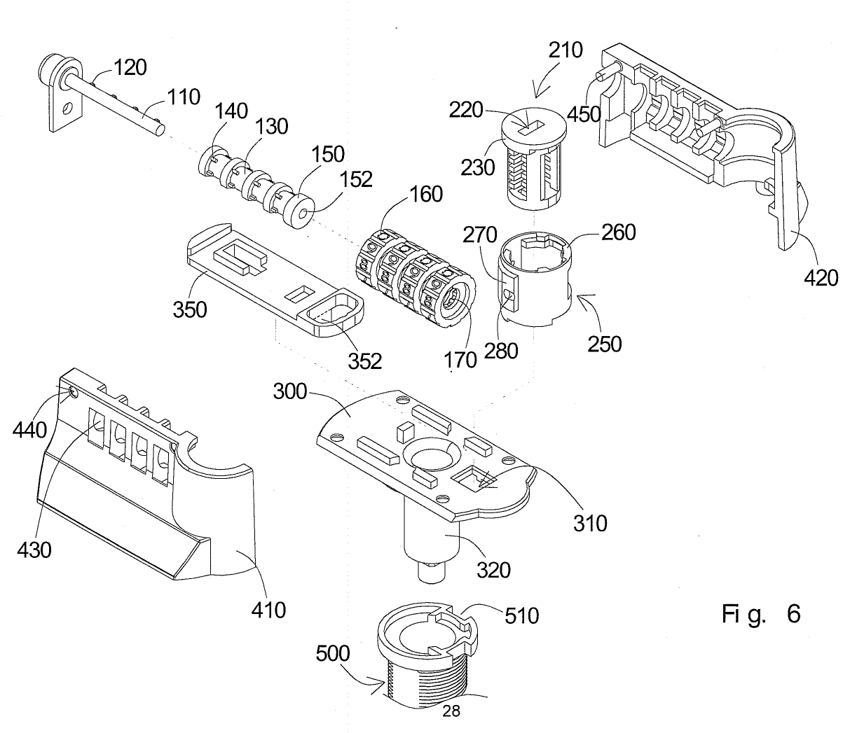

Please refer to FIG. 6 showing an exploded view of the lock mechanism 100 according to the present invention. As it can be seen from FIG. 6, the axial direction of combination lock 105 is substantially perpendicular to the axial direction of key lock 205. Furthermore, the axial direction of combination lock 105 and the axial direction of key lock 205 preferably cross, but are not limited thereto. For the combination lock 105, a roundel 150 is attached to the end of the set of shaft and a nub 152 is formed on the center of the roundel 150. In addition, the outer sleeve 250 further includes a protrusion 270 coming into contact with one end of the set of shaft when turning from the unlocked position to the reset position. The protrusion 270 is disposed on peripheral surface of the outer sleeve 250. In the preferred embodiment, the thickness of protrusion 270 is distributed increasingly from one end of protrusion 270 to the other end of protrusion 270, but is not limited thereto. The thickness of protrusion 270 can also be distributed the protrusion 270 includes a cam which occupies one-quarter circumference (substantially 90 degrees) of the outer sleeve 250, but is no limited thereto. The cam can also occupy other amount of circumference of the outer sleeve 250. Moreover, one end of the cam is preferably connected to the outer sleeve 250 and the other end of the cam preferably protrudes out of the outer sleeve 250. A concavity 280 is formed on the protrusion 270 of the outer sleeve 250 of the key lock 205, as shown in the figure. Furthermore, the lock body 210 of the key lock 205 has a pushing portion 230 and the outer sleeve 250 has flanges 260, as shown in FIG. 6.

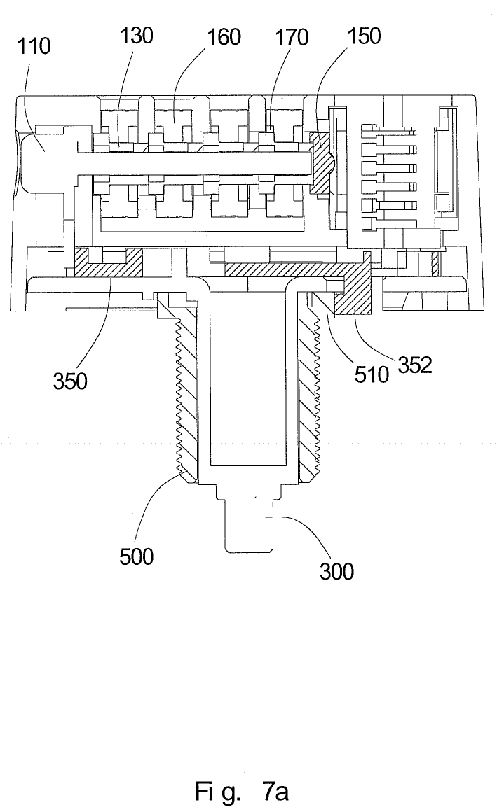

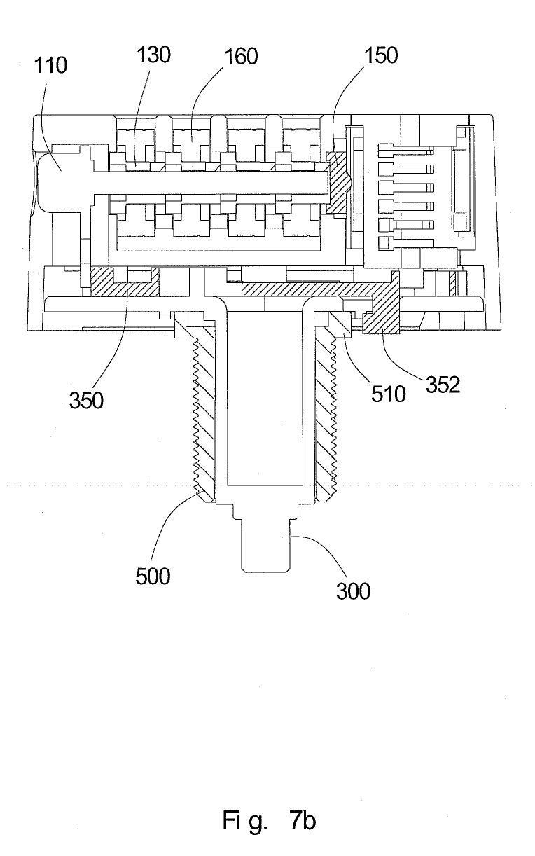

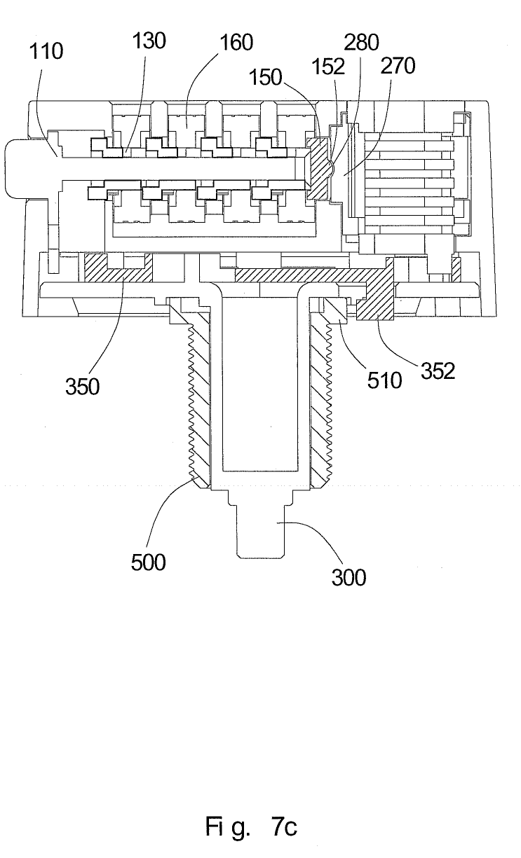

FIGS. 7a, 7b and 7c show cross sectional views of the lock mechanism 100 when the key lock 205 is in the locked status, in the unlocked status and in the reset status respectively. The difference between the locked status and unlocked status is the displacement of the hitch 352 of the secondary base 350. When the key lock 205 is in the locked status, the hitch 352 hooks up with the notch 510 of the fixing sleeve 500, as shown in FIG. 7a, and the fixing sleeve 500 is immovable. When a right key is inserted into the key lock 205 and turns the lock body 210 from the locked position to the unlocked position, a column attached to the bottom of the lock body 210 will causes the secondary base 350 to move and thus the hitch 352 moves away from the notch 510, as shown in FIG. 7b, therefore the fixing sleeve 500 is now movable.

Besides, when the lock body 210 reaches the unlocked position, the end connecting to the outer sleeve 250 of the protrusion 270 is set opposed to the roundel 150. As discussed above, the outer sleeve 250 is rotatable along with the lock body 210 from the unlocked position to the reset position, and the concavity 280 on the protrusion 270 is against and presses the nub 152 on the roundel 150 at the end of the set of shaft when the outer sleeve 250 rotates to the reset position, as shown in FIG. 7c. In other words, when the key lock 205 turns from the unlocked status to the reset status, the concavity 280 presses the roundel 150 at the end of the set of shaft and the set of shaft moves axially and outwardly in accordance with the pressed roundel 510. Next, when the key lock 205 reaches the reset status, the end protruding out of the outer sleeve 250 of the protrusion 270 is set opposed to the roundel 150 and the concavity 280 on the protrusion 270 contacts with the nub 152 on the roundel 150, as depicted in FIG. 7c. At the same time, the number wheels 160 disengage from the nodules 140 on the surface of the inner sleeve 130 since the set of shaft moves outwardly, and an observable space is created between the roundel 150 and the end of shaft 110.

In another embodiment, the key lock 205 of the lock mechanism 100 in accordance with the present invention is designed to work with two different keys, the change key and the master key. Similar to conventional key locks, a master key is designed to open a set of several locks, and these locks also have keys which are specific to each one, namely the change key, and cannot open any of the others in the set. In accordance with the preset invention, the change key will open only that specific key lock of the combined key and combination lock, while the master key will open that key lock and several others in a group.

In yet another embodiment of the present invention, the lock body 210 of the key lock 205 is replaceable and thereby numerous sets of the lock bodies with corresponding keys can be made for repeated applications of the lock mechanism 100 without concerning the specific key is lost or held by someone else.

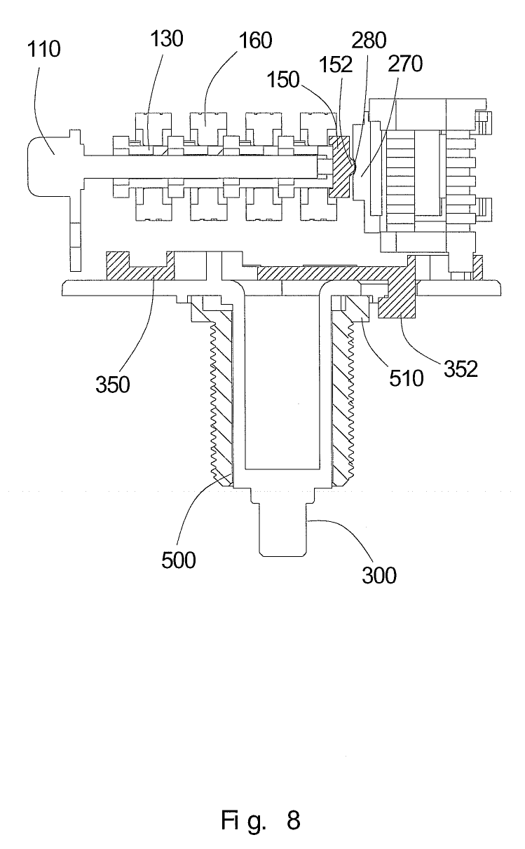

Similar to conventional combination locks, the combination lock 105 in accordance with the present invention has two statuses, a locked status and an unlocked status. When the combination lock 105 is in the locked status, as shown in FIG. 7a, the plurality of nodules 140 on the outer surface of the inner sleeve 130 engage with the cavities 170 inside the number wheels 160. When the protrusion 270 presses the set of shaft to the unlocked position, the nodules 140 disengages from the cavities 170, that is to say, the number wheels 160 disengages from the set of shaft, as shown in FIG. 8 illustrating the combination lock 105 is unlocked, and the combination is resettable at the moment. Similarly, as the combination lock 105 reaches the unlocked status from the locked status, the set of shaft will move axially and outwardly, and an observable space is created between the end of shaft 110 and the roundel 150.

The combined key and combination resettable lock in accordance with the present invention can be applied to lockers for rent, such as those in department stores and shopping centers. The lock is especially suitable for school lockers or gym lockers. At the beginning of the semester, the school administration can assign a preset lock to each student, and the student is not given the key and may only use the given combination to open the lock. The administration owns the keys to each locker and has the authority to open the locker for inspection when it suspect prohibited weapons or other items are hidden there. At the end of the semester, the administration takes back all the locks and preset other combinations to give another group of students in the next semester.

From the foregoing, it shall be appreciated that specific embodiments of the invention have been described herein for purposes of illustration, but that various modifications and alterations may be made by those skilled in the art without deviating from the spirit and scope of the invention. For example, it shall be understood that there is no intention to limit the invention to the specific forms disclosed, but on the contrary, the invention is to cover all modifications, alternate constructions and equivalents falling within the spirit and scope of the invention. Accordingly, the invention is not limited except as by the appended claims.

What is claimed is:

1. A lock mechanism comprising:
a combination lock having a set of shaft and a plurality of number wheels, wherein said set of shaft is axially movable and enclosed by said number wheels; and
a key lock having a lock body and an outer sleeve, said outer sleeve being selectively rotatable in accordance with said lock body, wherein said outer sleeve further includes a protrusion disposed on a peripheral surface of said outer sleeve;
wherein said outer sleeve is rotatable to a reset position, said protrusion presses an end of said set of shaft when said outer sleeve rotates to said reset position.

2. The lock mechanism of claim 1, wherein said set of shaft further includes a shaft and an inner sleeve, wherein said shaft is enclosed by said inner sleeve and said inner sleeve is enclosed by said number wheels, said shaft has a plurality of knobs operatively engaged with said inner sleeve, and said inner sleeve is movably engaged with said number wheels.

3. The lock mechanism of claim 2, wherein said inner sleeve includes a plurality of nodules and each of said number wheels includes a plurality of cavities, said nodules are movably disposed in said cavities.

4. The lock mechanism of claim 1, wherein said protrusion has an uneven thickness.

5. The lock mechanism of claim 1, wherein said protrusion has an even thickness.

6. The lock mechanism of claim 1, wherein an axial direction of said combination lock is perpendicular to an axial direction of said key lock.

7. The lock mechanism of claim 1, wherein said outer sleeve further includes a raised portion formed around a rim at one end of said outer sleeve, said raised portion has two ends and a spacing is formed between said two ends of raised portion, said lock body further includes a metal plate movably disposed in said spacing and between said two ends of raised portion.

8. The lock mechanism of claim 7, wherein said outer sleeve rotates together with said lock body when said metal plate collides with one of said ends of said raised portion.

9. The lock mechanism of claim 1 further comprising a base, wherein said combination lock and said key lock are disposed on said base.

10. The lock mechanism of claim 9 further comprising a secondary base, wherein said secondary base is disposed between said base and said combination lock as well as said key lock.

11. The lock mechanism of claim 10, wherein said base includes a square hole and said secondary base includes a hitch corresponding to said square hole.

12. The lock mechanism of claim 11 further comprising a fixing sleeve, wherein said fixing sleeve has at least one notch corresponding to said hitch.

13. The lock mechanism of claim 1, wherein the base includes a central part, extending from the base and enclosed by said fixing sleeve.

14. The lock mechanism of claim 1 further comprising a housing enclosing said combination lock and said key lock, wherein a plurality of openings corresponding to said number wheels.

15. The lock mechanism of claim 1, wherein said end of said set of shaft further includes a roundel.

16. The lock mechanism of claim 15 further comprising a concavity on said protrusion and a corresponding nub on said roundel, wherein said concavity couples with said nub when said protrusion collides against said roundel.

17. The lock mechanism of claim 15, wherein said lock body has a pushing portion and said outer sleeve has a flange, said pushing portion moves said flange to said reset position when said protrusion collides against said roundel.
